(19) United States
(12) Patent Application Publication
(10) Pub. No.: US 2006/0239530 A1
(43) Pub. Date: Oct. 26, 2006

(54) Computer-aided image diagnosis

(75) Inventor: Akira Oosawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/367,300

(22) Filed: Mar. 6, 2006

(30) Foreign Application Priority Data
Mar. 4, 2005 (JP) 060028-2005

(51) Int. Cl. G06K 9/00

(52) U.S. Cl. 382/130

(57) ABSTRACT

The respiratory function of the examinee is determined to be abnormal when a first shift is calculated by carrying out first matching processing where the position of each of a plurality of local areas forming the first image is brought into alignment with the corresponding position in the second image, a second shift is calculated for the local areas by carrying out second matching processing where the position of the local areas after the first matching processing is brought into alignment with the corresponding position in the third image, the difference between the first and second shifts is calculated and scatter of the calculated difference is larger than a predetermined threshold value.

### BACKGROUND OF THE INVENTION

1. Field of the Invention

This invention relates to a computer-aided image diagnostic method and system, and more particularly to a computer-aided method of and system for determining abnormality in the respiratory function of the person to be examined on the basis of a plurality of images of his or her chest representing different respiratory phases thereof.

2. Description of the Related Art

Recently, there have been various attempts to diagnose the respiratory function by the use of simplified x-ray images of the chest taken in a plurality of respiratory stages (phases) from expiration to inspiration.

For example, there has been reported that it is possible to detect abnormality in the ventilation from videos taken in a plurality of respiratory phases from expiration to inspiration with an I.I. (image intensifier) and it is necessary to bring the plurality of chest images into alignment with each other to detect abnormality in the expiration at a higher accuracy. (See, for instance, “Dynamic chest image analysis: model-based ventilation study with pyramid images” by J. Liang et al., Proceedings of SPIE medical imaging 1997: Physiology and Function from Multidimensional Images, SPIE, May 1997, Vol. 3033, pp. 81-92)

It has been suggested to use a digital x-raying system on which an FPD (flat-panel detector) applicable to videos is mounted and that information on the respiratory function can be obtained more accurately from change in density of the lung when videos of a resolution higher than those obtained by the I.I. are used. Further, various attempts at the analysis by subtraction videos by bringing adjacent images of the taken videos into alignment with each other and calculating the difference therebetween have been made. (See, for instance, “Quantitative Analysis of Respiratory Kinetics in Breathing Chest Radiographs Obtained Using a Dynamic Flat-Panel Detector” by Rie Tanaka et al., Journal of Medical Imaging and Information Sciences, January 2003, Vol. 20, No. 1, pp. 13-19)

On such a background, we, this applicant, have proposed to improve accuracy in matching of interesting images representing different respiratory phases by bringing in sequence the position of the object included in each of two interesting images which are not adjacent to each other when more than 3 medical chest images representing different respiratory phases are arranged in the order of the respiratory phases into alignment with that included in the adjacent image, and finally into alignment with that included in a reference image which provides a reference of matching and to facilitate viewing of a plurality of medical chest images taken in a plurality of respiratory phases by generating an image which visualizes the changes in density between images representing different respiratory phases and/or in position of a local area in the images. (For example, U.S. Patent Application Publication No. 20050025365)

However, in the papers described above, since the reader determines whether an abnormality is in the respiratory function viewing the videos representing different respiratory phases, subtraction videos of such videos, or images representing the change in density and/or in position, there remains a possibility that he or she overlooks the diseased part. In order to reduce such a possibility, it is necessary to elongate the time taken for reading the shadows, which leads to deterioration of the diagnostic efficiency.

### SUMMARY OF THE INVENTION

In view of the foregoing observations and description, the primary object of the present invention is to provide a method of and a system which can reduce the possibility of overlooking the diseased part and can shorten the reading time, thereby improving the diagnostic efficiency when the reader determines whether an abnormality is in the respiratory function on the basis of the videos representing different respiratory phases.

In accordance with the present invention, there is provided a computer-aided image diagnosis method characterized in that assuming that arbitrary three respiratory phases of the examinee are taken as first to third respiratory phases in the order of respiration and medical images respectively representing the first to third respiratory phases are taken as first to third images, it is determined that there is an abnormality in the respiratory function of the examinee when a first shift representing shift of a local area in response to the change from the first respiratory phase to the second respiratory phase is calculated for each of the local areas by carrying out first matching processing where the position of each of a plurality of local areas forming the first image is brought into alignment with the corresponding position in the second image, a second shift representing shift of the local area in response to the change from the second respiratory phase to the third respiratory phase is calculated for each of the local areas by carrying out second matching processing where the position of each of the local areas after the first matching processing is brought into alignment with the corresponding position in the third image, the difference between the first and second shifts is calculated and scatter of the calculated difference is larger than a predetermined threshold value.

In accordance with the present invention, there is further provided a computer-aided image diagnosis system for realizing the method. That is, the computer-aided image diagnosis system of the present invention comprises a shift calculating means which calculates a first shift representing shift of a local area in response to the change from the first respiratory phase to the second respiratory phase for each of the local areas by carrying out first matching processing where the position of each of a plurality of local areas forming the first image is brought into alignment with the corresponding position in the second image and a second shift representing shift of the local area in response to the change from the second respiratory phase to the third respiratory phase by carrying out second matching processing where the position of each of the local areas after the first matching processing is brought into alignment with the corresponding position in the third image, a scatter calculating means which calculates scatter of the difference between the first and second shifts and a determining means which determines that there is an abnormality in the respiratory function of the examinee when the calculated scatter is larger than a predetermined threshold value, arbitrary three respiratory phases of the examinee being taken as first to third respiratory phases in the order of respiration and medical images respectively representing the first to third respiratory phases being taken as first to third images.

Further, a computer program for causing a computer to execute the method of the present invention may be recorded in computer readable media. A skilled artisan would know that the computer readable media are not limited to any specific type of storage devices and include any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of this invention. Additionally, computer code/instructions include, but are not limited to, source, object and executable code and can be in any language including higher level languages, assembly language and machine language.

The present invention will be described in detail, hereinbelow.

It is preferred that “the first to third images” be obtained by detecting the lung in the image for each of a plurality of medical chest images representing different respiratory phases, calculating the ratio of the area of the detected lung to a maximum or minimum area of the lung detected from each of the medical chest images and selecting on the basis of the calculated ratios. Further, it is preferred that the first and third images be a maximum inspiration image where the area of the lung is maximized and a maximum expiration image where the area of the lung is minimized.

It is preferred that the local area be suitable in its size for viewing the respiratory function. For example, when the local area is of a size substantially equal to the tissue of 6 to 10 mm formed by a plurality of alveoli called a secondary lobule, local ventilating function can be efficiently viewed. Further, the local areas may overlap each other. Further, one local area may be covered by one pixel.

The “matching processing” is a non-linear processing for discretely shifting the local areas in the image and may be a combination of a global matching (where the local areas are substantially aligned with each other) which is a linear position transformation and a local matching (where the local areas are locally aligned with each other) which is a non-linear position transformation.

In the second matching processing where the position of each of the local areas after the first matching processing is brought into alignment with the corresponding position in the third image, the position of each of the local areas in the first image after the first matching processing may be brought into alignment with the corresponding position in the third image, or the position of each of the local areas after the first matching processing may be set in the second image and the position of each of the local areas in the second image may be brought into alignment with the corresponding position in the third image.

The “difference between the first and second shifts” means a rate of change of shift between the first and second shifts.

The “shift” and the “difference” are values expressed by direction and/or size.

“Scatter of the difference” represents the degree of scatter of the difference. For example, the scatter of the difference may be variance or standard deviation of the difference. Here it is assumed that as the value of the “scatter of the difference increases, the scatter increases. If the relation is as the value of the “scatter of the difference increases, the scatter decreases, the relation of the values in the following “determination” is reversed.

Not only when the scatter is larger than a predetermined threshold value but also when the scatter is equal to the predetermined threshold value, it may be determined that there is an abnormality in the respiratory function. That is, when the scatter is not smaller than the predetermined threshold value, it may be determined that there is an abnormality in the respiratory function.

It is preferred that the predetermined threshold value be set on the basis of the regular scatter which is obtained on the basis of medical chest images when the respiratory function of the examinee is regular. Specifically, the predetermined threshold value may be a value having an allowable range to the regular scatter. The regular scatter may be obtained in advance or may be obtained every time the determination is made by preparing both the images to be examined and the images when the respiratory function of the examinee is regular.

Further, an interesting area may be set in the corresponding position of the first to third images and the scatter may be calculated on the local area in the interesting area. It is preferred there that the interesting area be set in the area of lung. The area of lung can be detected by a known method. For example, see Japanese Unexamined Patent Publication No. 2003-006661. The interesting area should be set to include a plurality of local areas. The interesting area may be set in a plural. In this case, the scatter may be calculated by the interesting areas. Further, the interesting areas may overlap each other.

Further, when it is determined that there is an abnormality in the respiratory function of an examinee, it is preferred that the first and/or the second shifts of the local area where the scatter of the first and/or the second shifts is larger than the predetermined threshold value be displayed in a distinguishable manner where the scatter of the first and/or the second shifts thereof can be distinguished from those of the other local areas. Further, when the scatter is calculated by the interesting areas, the interesting area where the scatter of the first and/or the second shifts is larger than the predetermined threshold value be displayed in a distinguishable manner where it can be distinguished from the other interesting areas. For example, the first and/or the second shifts of the local area where the scatter of the first and/or the second shifts is larger than the predetermined threshold value or the interesting area where the scatter of the first and/or the second shifts is larger than the predetermined threshold value may be displayed in a different color.

The present invention is based on the fact that the direction and/or the size of the shift of each of the local areas in response to change of the respiratory phase differs depending on whether there is an abnormality in the respiratory function of the examinee. FIG. 1A schematically shows in vector the shift of each of the local areas in response to change of the respiratory phase from the expiration to the inspiration when the respiratory function is regular, and FIG. 1B shows the distribution of the directions and the sizes of the vectors. FIGS. 2A and 2B are views respectively similar to FIGS. 1A and 1B when the respiratory function is abnormal. In the upper side of each of FIGS. 1A and 2A, air is taken in the lung and the lung is inflated as the respiratory phase changes from n to n+2, and in the lower side of each of FIGS. 1A and 2A, change of the position of each of the local areas in the rectangular area in FIGS. 1A and 2A is shown in vector (will be referred to as “a shift vector”, hereinbelow). As shown in FIGS. 1A, 1B, 2A and 2B, the distribution of the directions and the sizes of the shift vectors is substantially constant when the respiratory function is normal (FIG. 1B) whereas the distribution of the directions and the sizes of the shift vectors is dispersed from a respiratory phase to another when the respiratory function is abnormal (FIG. 2B).

In accordance with the method of and the system for aiding diagnosis with a computer, since it is automatically determined that the respiratory function of the examinee is abnormal when matching of each of a plurality of local areas in images representing arbitrary three respiratory phases is carried out, shift between the images of each of the local areas is obtained and the scatter of the difference (the rate of change) of the shift is larger than a predetermined threshold value, it is possible to attract attention of the reader on the basis of result of determination, which contributes to reduction of the possibility of overlooking the diseased part and can shorten the reading time, thereby improving the diagnostic efficiency.

Further, when the three images to be processed are selected on the basis of the area of the lung detected from a plurality of images representing different respiratory phases and the ratios of the area to a maximum value and a minimum value of the lung detected from each of the images, images more suitable for the diagnosis such as a maximum inspiration image or a maximum expiration image can be used for the determination, whereby the accuracy in determination is improved and the diagnostic accuracy and the diagnostic efficiency of the reader can be improved, since the respiratory phase of the prospective images can be estimated on the basis of the ratios.

When the predetermined threshold value is set on the basis of the regular scatter which is obtained on the basis of input of images when the respiratory function of the examinee is regular, it can be possible to reduce the determination error due to an individual difference, whereby the accuracy in determination is further improved and the diagnostic accuracy and the diagnostic efficiency of the reader can be further improved.

Further, when the scatter is calculated on the local area in the interesting area set in the corresponding position of the first to third images, whether there is an abnormality in the respiratory function can be determined on the basis of the direction and/or the size of the shift between the respiratory phases of the local area which are more important in the diagnosis. Accordingly, the accuracy in determination is further improved and the diagnostic accuracy and the diagnostic efficiency of the reader can be further improved.

Further, when the first and/or the second shifts of the local area where the scatter of the first and/or the second shifts is larger than the predetermined threshold value is displayed in a distinguishable manner where the scatter of the first and/or the second shifts thereof can be distinguished from those of the other local areas or when the interesting area where the scatter of the first and/or the second shifts is larger than the predetermined threshold value is displayed in a distinguishable manner where it can be distinguished from the other interesting areas when it is determined that there is an abnormality in the respiratory function of an examinee, the reader can be informed of not only whether there is an abnormality in the respiratory function of an examinee but also the diseased part. Accordingly, the diseased part can be more easily recognized and the diagnostic efficiency of the reader can be further improved.

### BRIEF DESCRIPTION OF THE DRAWINGS

FIG. 1A schematically shows in vector the shift of each of the local areas in response to change of the respiratory phase from the expiration to the inspiration when the respiratory function is regular,

FIG. 1B shows the distribution of the directions and the sizes of the vectors shown in FIG. 1A,

FIG. 2A schematically shows in vector the shift of each of the local areas in response to change of the respiratory phase from the expiration to the inspiration when the respiratory function is abnormal,

FIG. 2B shows the distribution of the directions and the sizes of the vectors shown in FIG. 2A,

FIG. 3 is a computer-aided chest image diagnostic system in accordance with an embodiment of the present invention,

FIG. 4 is a block diagram showing a logical arrangement and flow of data in the image processing server having the image processing function in accordance with a first embodiment of the present invention,

FIG. 5 is a view of a flow chart showing flow of the image processing executed by the first embodiment of the present invention,

FIG. 6 is a view schematically showing the processing to be executed in the shift calculating means and the scatter calculating means

FIG. 7 is a view for illustrating the global matching to be carried out by the shift calculating means,

FIG. 8 is a view for illustrating the local matching to be carried out by the shift calculating means,

FIG. 9 is a view for illustrating the shift of the central pixel of the local areas obtained by the local matching to be carried out by the shift calculating means,

FIG. 10 is a view showing an example of the local shift vectors,

FIG. 11 is a block diagram showing a logical arrangement and flow of data in the image processing server having the image processing function in accordance with a second embodiment of the present invention, and

FIG. 12 is a view of a flow chart showing flow of the image processing executed by the second embodiment of the present invention.

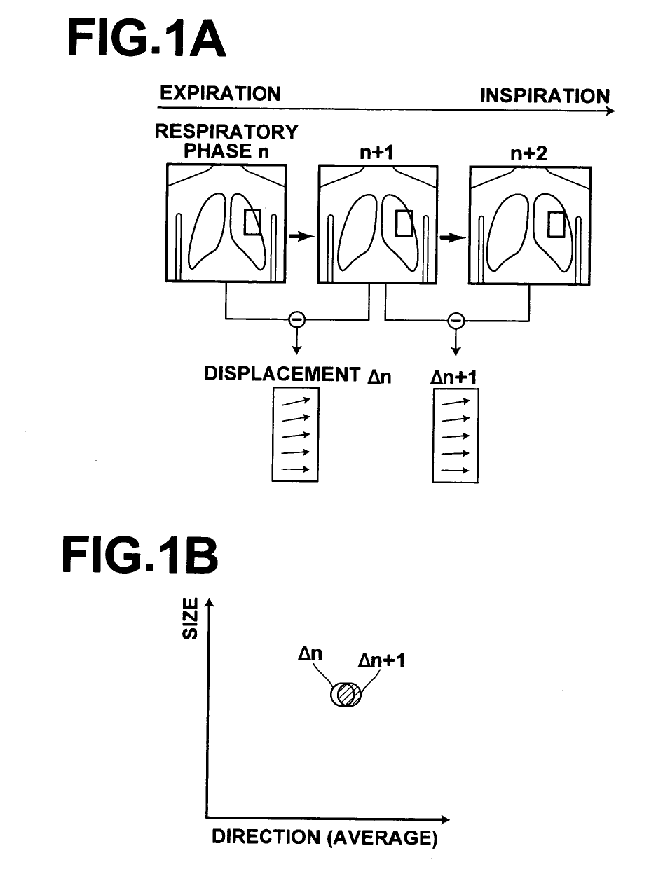

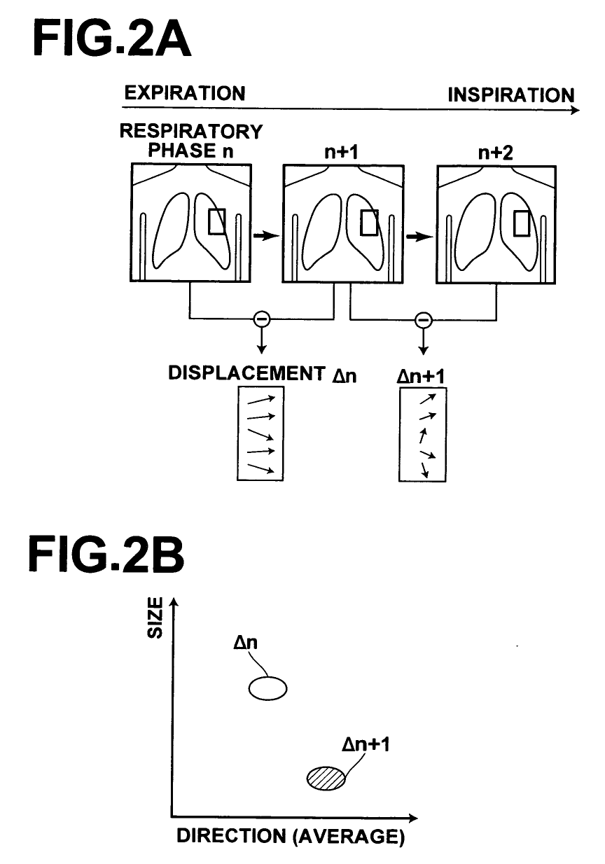

### DESCRIPTION OF THE PREFERRED EMBODIMENTS

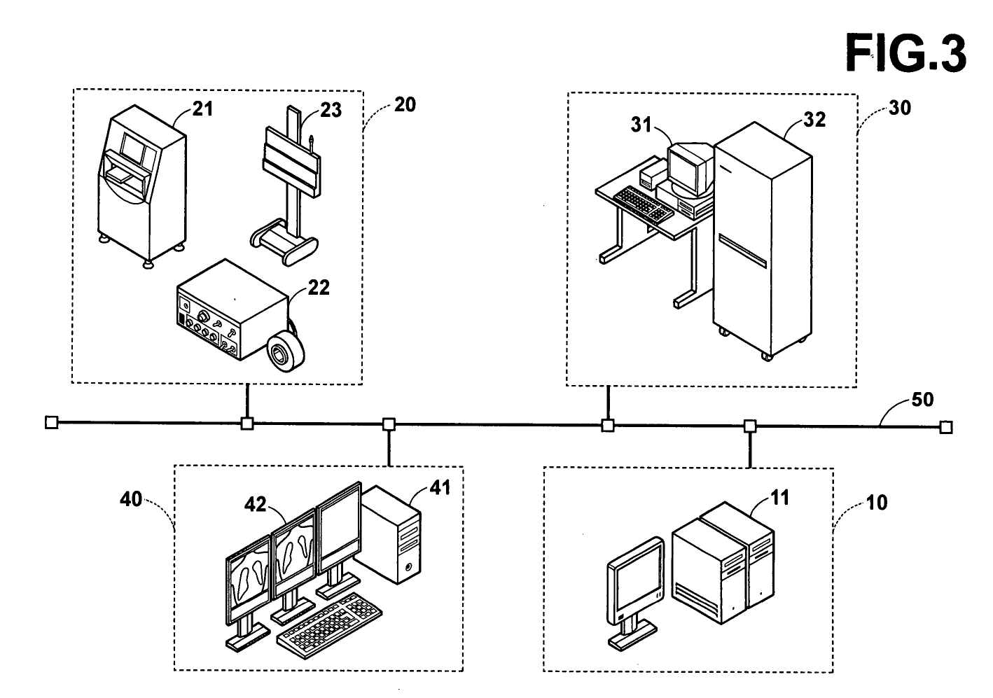

FIG. 3 is a computer-aided chest image diagnostic system in accordance with an embodiment of the present invention. As shown in FIG. 3, an image taking/read-out system 20 is connected to an image managing system 30, an image processing system 10 and an image displaying system 40 to be communicable through a network 50 such as LAN.

The image taking/read-out system 20 is for obtaining radiation images representing a plurality of respiratory phases of a patient and includes a CR (computed radiography) system 21, I.I. 22, a digital x-raying system having an FPD applicable to videos (will be referred to as “FPD system”, hereinbelow) 23 and the like.

The image processing system 10 carries out image processing on the radiation images taken by the image taking/read-out system 20 to generate images suitable for reading the shadows by the reader and includes an image processing server 11 and the like. The computer-aided image diagnostic method (system) in accordance with the present invention is used in the image processing server 11.

The image managing system 30 reserves and manages the images generated by the image taking/read-out system 20 and/or the image processing system 10 and includes an image managing server 31, an external mass storage device 32, database managing software (e.g., ORDB (object relational database) managing software) and the like. Each of the images is linked with information on the examinee such as the ID, the name, the gender or the date of birth of the examinee and is stored in the external mass storage device 32 under the management by the database managing software.

The image displaying system 40 displays the images generated by the image taking/read-out system 20 and/or the image processing system 10 and includes a client PC 41, a fine liquid crystal display 42, and the like. Further, it is possible to set the reading conditions such as images to be read and an image processing method which is to be carried out on the images by the use of an input system such as a keyboard or a mouse of the client PC 41.

In a first embodiment of the present invention, an abnormality in the respiratory function of the examinee is automatically determined on the basis of medical chest images P1 to PN representing a plurality of respiratory phases of the examinee in the order thereof and when it is determined that there is an abnormality in the respiratory function of the examinee, a local area shift vector image representing a change of each of the local areas in the images is generated. In the following description, image P1 represents a maximum expiration (respiratory phase 1), image PN represents a maximum inspiration (respiratory phase N) and image Pn represents a respiratory phase n.

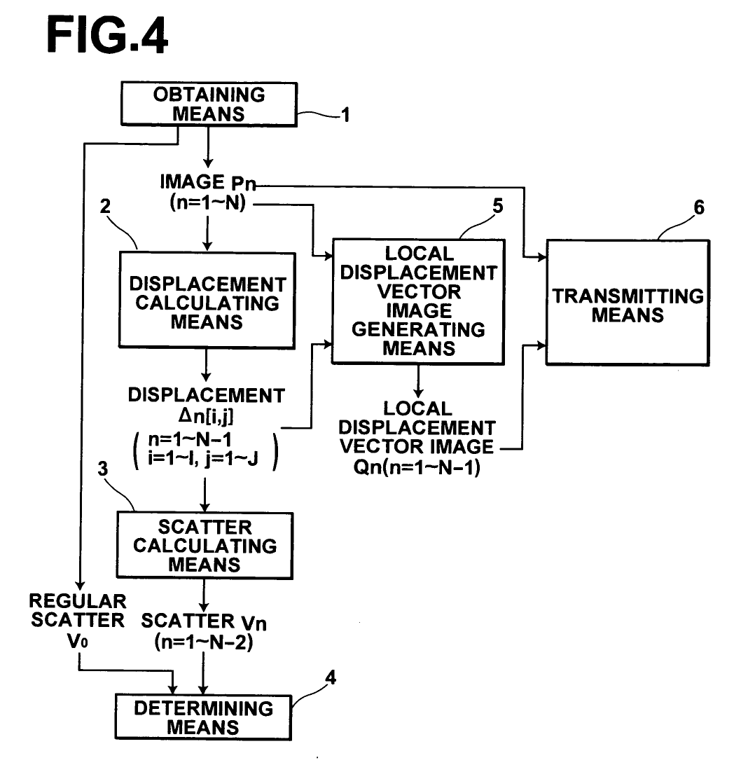

FIG. 4 is a block diagram showing a logical arrangement and flow of data in the image processing server 11 having the image processing function. As shown in FIG. 4, the image processing server 11 comprises an obtaining means 1 which obtains images P1, . . . ,Pn, . . . ,PN and/or a regular scatter V0 (to be described later) from the image managing system 30, a shift calculating means 2 which calculates the shifts Δ 1[1,1] to Δ1[I,J], . . . ,Δn[1,1] to Δn[I,J], . . . ,ΔN−1[1,1] to ΔN−1[I,J] of each of local areas R1[1,1] to R1[I,J] in response to change of the respiratory phase between the images by dividing the image P1 into local areas R1[1,1], . . . ,R1[i,j], . . . R1[I,J] out of the obtained images P1 to PN and carrying out in sequence matching processing where the positions of the divided local areas R1[1,1] to R1[I,J] are aligned with the corresponding positions in the images P2 to PN, a scatter calculating means 3 which calculates the scatter of the difference in shifts V1, . . . ,Vn, . . . ,VN-2 by the shifts of the local areas between the images, a determining means 4 which determines that there is an abnormality in the respiratory function of the examinee when each of the calculated scatter V1, . . . ,Vn, . . . ,VN-2 is larger than a threshold value Th set according to the regular scatter V0 obtained by the obtaining means 1, a local shift vector image generating means 5 which generates local shift vector images Q1, . . . ,Qn, . . . ,QN-1 which visualize the shift of each of the local areas and a transmitting means 6 which transmits to the client PC 41 the maximum inspiration image PN when it is determined that there is no abnormality in the respiratory function of the examinee and transmits to the client PC 41 the maximum inspiration image PN and the local shift vector images Q1 to QN-1 when it is determined that there is an abnormality in the respiratory function of the examinee.

Each of the means described above is realized in association with a CPU, a main storage system, an external storage means, an input/output interface, an operating system and the like of the image processing server 11 by executing a program installed in the image processing server 11 from a storage medium such as CD-ROM. Further, the order of processing is controlled by the program.

Flow of processing in the image processing server 11 in accordance with the first embodiment of the present invention will be described, hereinbelow.

In the image taking/read-out system 20, for instance, the video applicable FPD system 23 takes images of the chest of a patient and N(N≧3) images representing a plurality of respiratory phases from a maximum expiration image P1 to a maximum inspiration image PN are generated. The generated images are respectively linked with attached information such as information on the examinee, information on the examination and the like and stored in a file by the images and N files are output. The output N files are transmitted to the image managing system 30 by way of the network 50. In this embodiment, it is assumed that the maximum inspiration image and the maximum expiration image are identified and information identifying the maximum inspiration image and the maximum expiration image is included in the attached information.

The image managing system 30 receives the transmitted N files and stores the image data in the N files linked with the attached information in the external mass storage device 32 on the basis of a data format and a data structure determined by the database managing software. The stored image data can be retrieved by a part or the all of the attached information such as the ID of the examinee or the date of examination.

The reader operates the client PC 41 to designate the attached information such as the ID of the examinee or the date of x-raying and the pattern of reading (automatic determination of the abnormal respiratory function) and requests execution of the processing. By designating the attached information described above, an image to be read is identified out of the images P1 to PN, and by designating the pattern of reading, the contents of image processing necessary for the reading are identified.

The attached information and the pattern of reading designated through the client PC 41 are sent to the image processing server 11 and the image processing server 11 starts an image processing program which generates an image necessary for the reading, that is, a program which causes the image processing server 11 to function as means shown in FIG. 4, on the basis of the pattern of reading received.

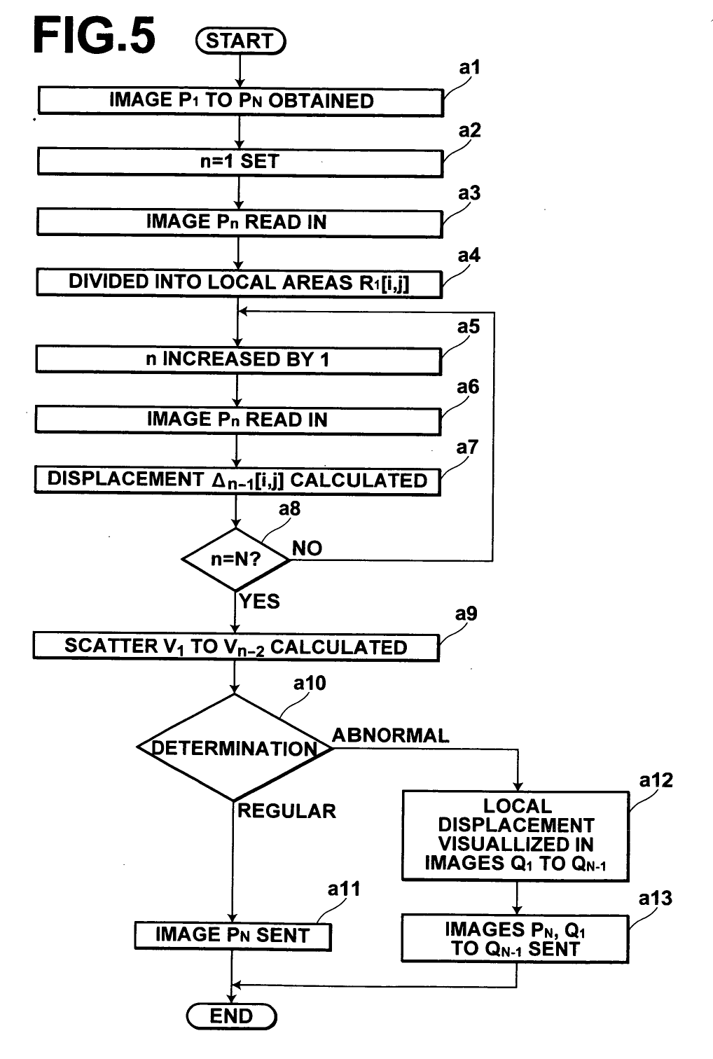

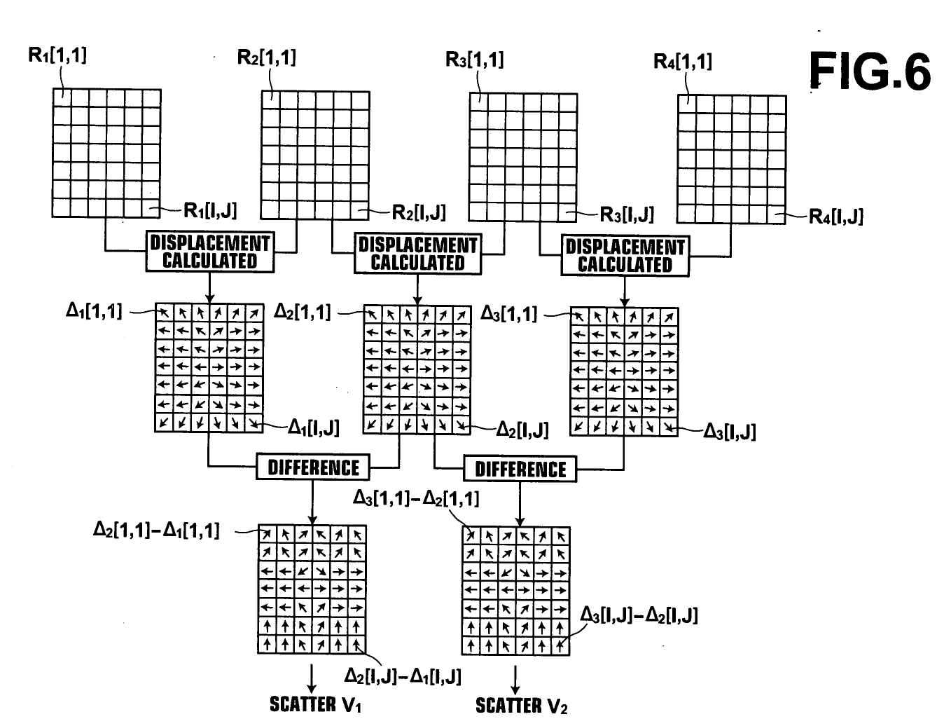

FIG. 5 is a view of a flow chart showing flow of processing executed by the started image processing program, and FIG. 6 is a view schematically showing the processing to be executed in the shift calculating means 2 and the scatter calculating means 3.

First the obtaining means 1 transmits a request for retrieval from the database of the image managing system 30 by the retrieving conditions based on the attached information received from the client PC 41. The image managing server 31 retrieves from the database according to the request for retrieval received to obtain the images P1 to PN matching to the retrieving conditions and the regular scatter V0 to be described later and send them to the image processing server 11. The obtaining means 1 of the image processing server 11 receives the images P1 to PN and the regular scatter V0 and temporarily stores them in the main storage system or an external storage system of the image processing server 11. (step a1)

Then after the value of the affix n is set to 1 (step a2), the shift calculating means 2 reads in the image Pn (=P1) (step a3) and sets local areas R1[1,1], . . . ,R1[i,j], . . . ,R1[I,J] by dividing the image Pn (=P1) into I×J (lateral×longitudinal) local areas (step a2) Each of the local area is a rectangular area which includes a tissue of 6 to 10 mm formed by a plurality of alveoli called a secondary lobule, and the number of the local areas is determined on the basis of the size.

Then after the value of the affix n for distinguishing the images is added by 1 to 2 (step a5), the shift calculating means 2 reads in the image Pn (=P2) (step a6) and carries out matching processing where the positions of the local areas R1[1,1] to R1[I, J] are respectivelybrought into alignment with the corresponding positions in the image P2, thereby calculating the shifts Δ1[1,1] to Δ1[I,J] of each of local areas R1[1,1] to R1[I,J] in response to change from respiratory phase 1 to respiratory phase 2 (step a7). The method of subtraction with time disclosed in U.S. Patent Application Publication No. 20050025365 described above is employed, here, as will be described in detail, hereinbelow.

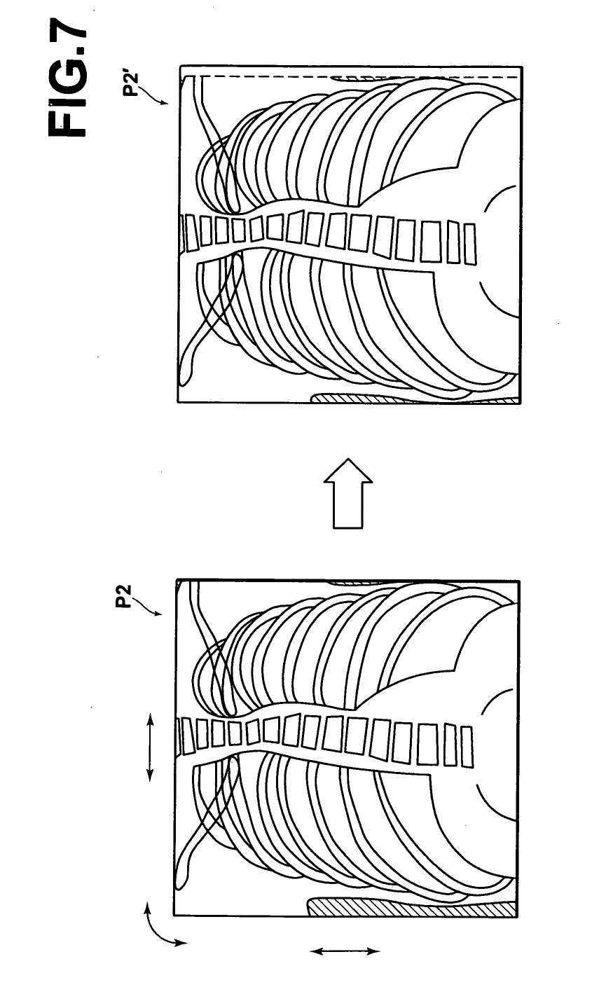

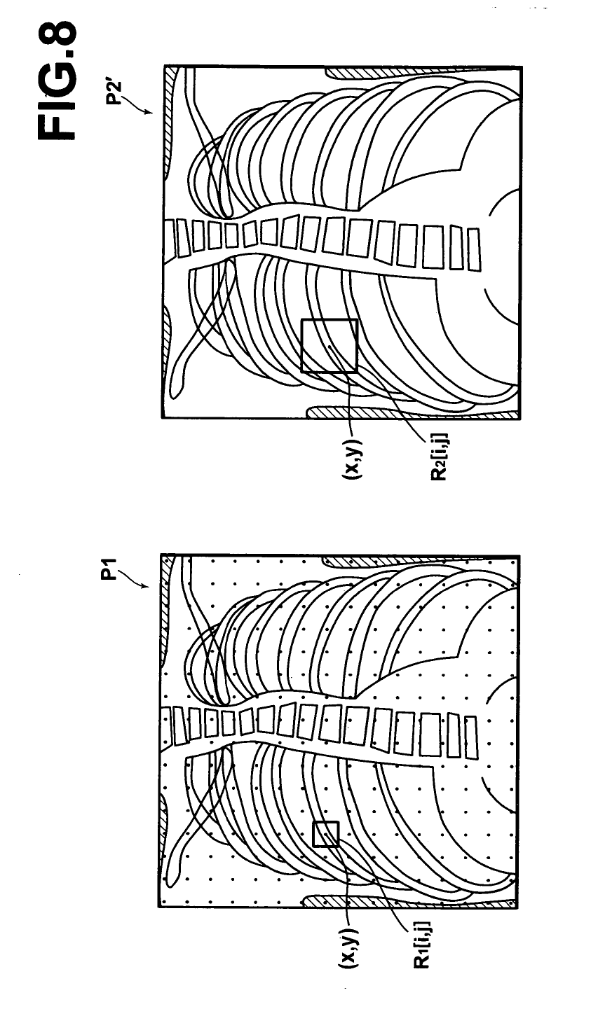

The images P1 and P2 are first approximately matched (global matching). This processing is a processing where affine transformation (rotation, translation) is carried out on an image P2 so that the image P2 conforms to the image P1, and the image P2 is transformed to an image P2′ as shown in FIG. 7 by this processing.

After completion of the global matching, local matching is carried out.

Specifically, the central pixels of the local areas R1[1,1] to R1[I,J] in the image P1 is expressed in x-y coordinate system (x,y). Further, searches ROI R2′[1,1], . . . ,R2′[i,j], . . . ,R2′[I,J] are set on the image P2′. The searches ROI are areas which are set in correspondence to the local areas R1[1,1] to R1[I,J], have a common center (x,y) and larger than t. The searches ROI are areas which are four times (double in both the longitudinal direction and the lateral direction) as large as the local areas R1[1,1] to R1[I,J], here.

The local areas R1[1,1] to R1[I,J] in the image P1 are moved within each of the searches ROI set on the image P2′, and the positions where the degree of matching of the local areas is maximized (the centers (x′,y′) of the local areas R1[1,1] to R1[I,J]) are obtained by the searches ROI. The index of the degree of matching may be an index by a least square method or a cross-relation.

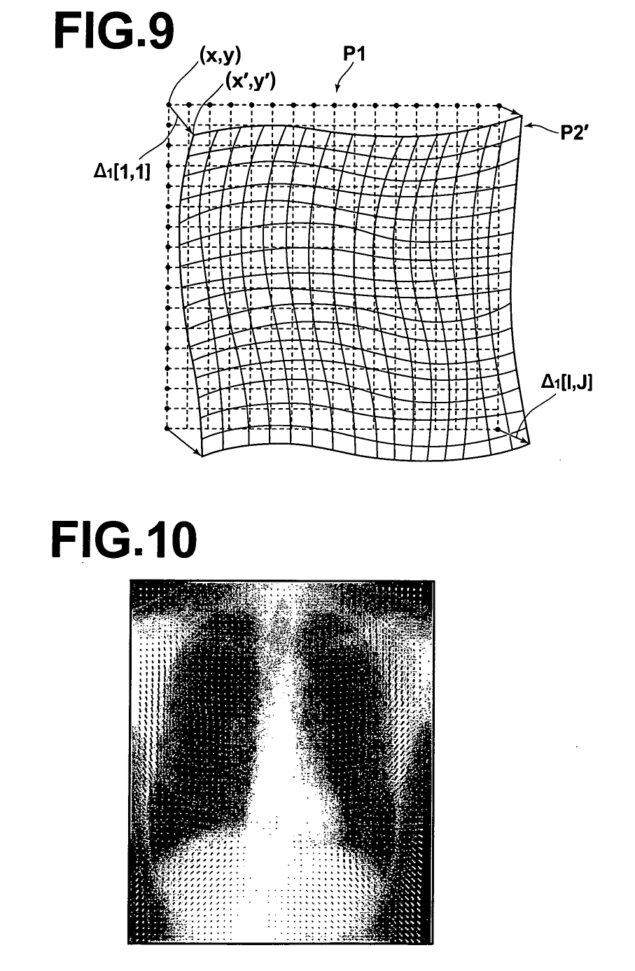

Then the value of shift (Δx, Δy) of the local areas R1[1,1] to R1[I,J] is obtained (Δx=x′−x, Δy=y′−y) for each of the central pixel (x,y), whereby the shifts (Δ1[1,1] to Δ1[I,J]) of the local areas R1[1,1] to R1[I,J] in response to change from respiratory phase 1 to respiratory phase 2 are obtained. FIG. 9 is a view schematically showing the central pixels (x,y), and (x′,y′) of the images P1 and P2′ and the shift (Δ1[1,1]) therebetween. As can be seen from FIG. 9, the shift of each of the local areas is an amount of vector having both the direction and the size.

When the value of the affix n is further added by 1 to 3 (step a5), the shift calculating means 2 moves the local areas R1[1,1] to R1[I,J] after the matching within each of the searches ROI set on the image P3′ to obtain the positions where the degree of matching of the local areas is maximized by the searches ROI as in the manner described above. Then the value of shift of the local areas is obtained for each of the central pixel, whereby the shifts (Δ2[1,1] to Δ2[I,J]) of the local areas R1[1,1] to R1[I, J] in response to change from respiratory phase 2 to respiratory phase 3 are obtained. (steps a6 and a7)

Then, the value of the affix n is continuously added by 1 (step a5), and the shift calculating means 2 moves the local areas R1[1,1] to R1[I,J] after the preceding matching within each of the searches ROI set on the image Pn′ to obtain the positions where the degree of matching of the local areas is maximized by the searches ROI as in the manner described above. Further the value of shift of the local areas is obtained for each of the central pixel, whereby the shifts (Δn−1[1,1] to Δn−1[I,J]) of the local areas R1[1,1] to R1[I,J] in response to change from respiratory phase n−1 to respiratory phase n are obtained (steps a6 and a7). These steps are repeated until the value of the affix n becomes N in step a8.

When, the value of the affix n reaches N in step a8, that is, when the shifts (Δ1[1,1] to Δ1[I,J]) . . . , (Δn[1,1] to Δn[I,J]) . . . , (ΔN−1[1,1] to ΔN−1[I,J]) of the local areas R1[1,1] to R1[I,J] in response to change from respiratory phase 1 to respiratory phase N are obtained, the scatter calculating means 3 obtains the differences (Δn+1[1,1]-Δn[1,1]) . . . , (Δn+1[i,j]-Δn[i,j]) . . . , (Δn+1[I,J]-Δn[I,J]) between the shifts of the local areas between images for the natural numbers n from 1 to N−2, and calculates the divergence of these differences as a scatter Vn. (step a9) Thus, the values of the scatters V1, . . . ,Vn, . . . ,VN-2 have been obtained. Since the shift of each of the local areas is an amount of vector having both the direction and the size, the difference therebetween is also an amount of vector. Accordingly, the variance of the value which represents the angle (e.g., radian or tangent) which the vector representing the difference between the shifts makes with the direction of x-axis may be the scatter of the direction or the variance of the length of the vector representing the difference between the shifts may be the scatter of the size.

Then the determining means 4 reads in the regular scatter V0 obtained by the obtaining means 1 and determines that there is an abnormality in the respiratory function of the examinee when the scatter V1 to VN-2 includes a value larger than the threshold value Th (in this embodiment, Th=αV0+β, α and β being allowable constants obtained on the basis of clinical data) and that there is no abnormality in the respiratory function of the examinee when the scatter V1 to VN-2 includes no value larger than the threshold value Th. (step a10) The regular scatter V0 is the average of the scatters obtained in the same manner as that described above on the basis of medical chest images when it was determined in the past that the respiratory function of the examinee was regular. It is preferred that the medical chest images when it was determined in the past that the respiratory function of the examinee was regular be taken in the manner same as that of the current x-raying (e.g., in the timing of x-raying and the respiratory phase, and the number of images)

When it is determined by the determining means 4 that the respiratory function of the examinee is regular, the transmitting means 6 sends only the image data of the maximum inspiration image PN to the client PC 41. (step a11)

On the other hand, when it is determined by the determining means 4 that the respiratory function of the examinee is abnormal, the local shift vector image generating means 5 generates local shift vector images Qn, which visualize the direction and/or the size of the shift Δn[1,1] to Δn[I,J] of each of the local areas as the shift vectors, having a starting point in the position of the central pixel of each of the local areas in the image Pn for the natural numbers n from 1 to N−1. FIG. 10 is a view showing an example of the generated local shift vector image. As shown in FIG. 10, the direction and the size of the shift of each of the local areas is expressed by a rod having a starting point in the position of the central pixel of each of the local areas. The transmitting means 6 sends the image data representing the generated local shift vector images Q1 to QN-1 and the maximum inspiration image PN to the client PC 41. (step a13)

The client PC 41 causes the fine liquid crystal display 42 to display the maximum inspiration image PN on the basis of the image data received from the image processing server 11 when it is determined by the determining means 4 that the respiratory function of the examinee is regular. Whereas, the client PC 41 causes the fine liquid crystal display 42 to display in one screen the maximum inspiration image PN on the basis of the image data received from the image processing server 11 and in another screen the local shift vector images Q1 to QN-1 in a video-like fashion in the order of change in the respiratory phase when it is determined by the determining means 4 that the respiratory function of the examinee is abnormal.

As described above, in the first embodiment of the present invention, the shift calculating means 2 carries out in sequence matching processing where the positions of the local areas R1[1,1] to R1[I,J] in the images P1 are aligned with the corresponding positions in the images P2 to PN, and calculates the shifts (Δ1[1,1] to Δ1[I,J]) . . . , (Δn[1,1] to Δn[I,J]) . . . , (ΔN−1[1,1] to ΔN−1[I,J]) of the local areas R1[1,1] to R1[I,J] in response to change of the respiratory phases, the scatter calculating means 3 calculates the scatters V1 to VN-2 of the differences of the shifts of the local areas for each of the shifts of the local areas between the images, and the determining means 4 automatically determines that there is an abnormality in the respiratory function of the examinee when the scatter V1 to VN-2 includes a value larger than the threshold value Th. Accordingly, it is possible to attract attention of the reader on the basis of result of determination, which contributes to reduction of the possibility of overlooking the diseased part and can shorten the reading time, thereby improving the diagnostic efficiency.

Further, since the threshold value Th is set by the determining means 4 on the basis of the regular scatter V0 which is obtained on the basis of medical chest images when the respiratory function of the examinee is regular, it can be possible to reduce the determination error due to an individual difference between different examinees, whereby the errors in determination are reduced and the diagnostic accuracy and the diagnostic efficiency of the reader can be further improved.

Further, since when it is determined by the determining means 4 that the respiratory function of the examinee is regular, the fine liquid crystal display 42 is caused to display the maximum inspiration image PN and when it is determined by the determining means 4 that the respiratory function of the examinee is abnormal, the local shift vector image generating means 5 generates local shift vector images Q1 to QN-1 which visualize the shifts of the local areas in the images in response to change of the respiratory phases on the basis of the images P1 to PN and the shifts Δ1[1,1] to Δ1[I,J]) . . . , (Δn[1,1] to Δn[I,J]) . . . , (ΔN−1[1,1] to ΔN−1[I,J] and the generated images are displayed on the fine liquid crystal display 42 of the client PC 41, the diagnostic efficiency of the reader can be improved by changing the image to be provided for reading according to the result of determination.

The local shift vector image generating means 5 may compare each of the differences (Δn+1[1,1]-Δn[1,1]) . . . , (Δn+1[i,j]-Δn[i,j]) . . . , (Δn+1[I,J]-Δn[I,J]) between the shifts with the predetermined threshold value Th for the natural numbers n from 1 to N−2, and in the local area where the difference between the shifts is larger than the predetermined threshold value Th, may generate a local shift vector image Qn of a color different from the other areas when visualizing the shift vector, whereby the reader can be informed of not only whether there is an abnormality in the respiratory function of an examinee but also the diseased part and accordingly, the diseased part can be more easily recognized and the diagnostic efficiency of the reader can be further improved.

Further, the local shift vector image generating means 5 may generate warp images P1″ to PN-1″ which are obtained by matching the positions of the object in images P1 to PN with the corresponding position in the maximum inspiration image PN by carrying out approximating processing with a two-dimensional ten-order fitting polynomial for the natural numbers n from 1 to N−1 on the basis of the shifts Δn[1,1] to Δn[I,J]) of the central pixels of the local areas, thereby obtaining the shifts of all the pixels in the image Pn in response to change from the respiratory phase n to respiratory phase n+1 and by carrying out non-linear strain transforming processing (warping) where each of the pixels in the image Pn is shifted on the basis of the sum of the shifts of each pixel in response to change from the respiratory phase n to respiratory phase N, and may generate a matched local shift vector image Qn′ for the natural numbers n from 1 to N−1 which image visualizes the direction and/or the size of the shifts Δn[1,1] to Δn[I,J] with the position of the central pixel in the warp image Pn″ employed as the starting point. With this arrangement, since the matched local shift vector images Q1′ to QN-1′ are images where the positions of each local areas in the images have been matched with the corresponding positions in the maximum inspiration image PN, the shift of each of the local areas can be more easily recognized and the diagnostic accuracy and the diagnostic efficiency can be improved.

In a second embodiment of the present invention, that the respiratory function is abnormal is automatically determined on the basis of a maximum expiration image P11, an intermediate image P12 and a maximum inspiration image P13 selected from more than three medical chest images (will be referred to as “the diagnostic image”, hereinbelow) representing different respiratory phases of an examinee and a maximum expiration image P21, an intermediate image P22 and a maximum inspiration image P23 selected from more than three medical chest images (will be referred to as “the regular image”, hereinbelow) representing different respiratory phases of the examinee when the respiratory function of the examinee is normal; and when it is determined that the respiratory function is abnormal, an enhanced image where the abnormal part is enhanced is generated. The term “the regular image” as used here means a medical chest image read when the examinee was diagnosed in the past that the respiratory function is normal. The affix t of the sign Ptn representing an image means a type of the image, “1” meaning a diagnostic image and “2” meaning a regular image, and the other affix nmeans a respiratory phase, “1” meaning a maximum expiration image, “3” meaning a maximum inspiration image and “2” meaning an image between the maximum expiration image and the maximum inspiration image. Affixes of other signs in the following description are the same.

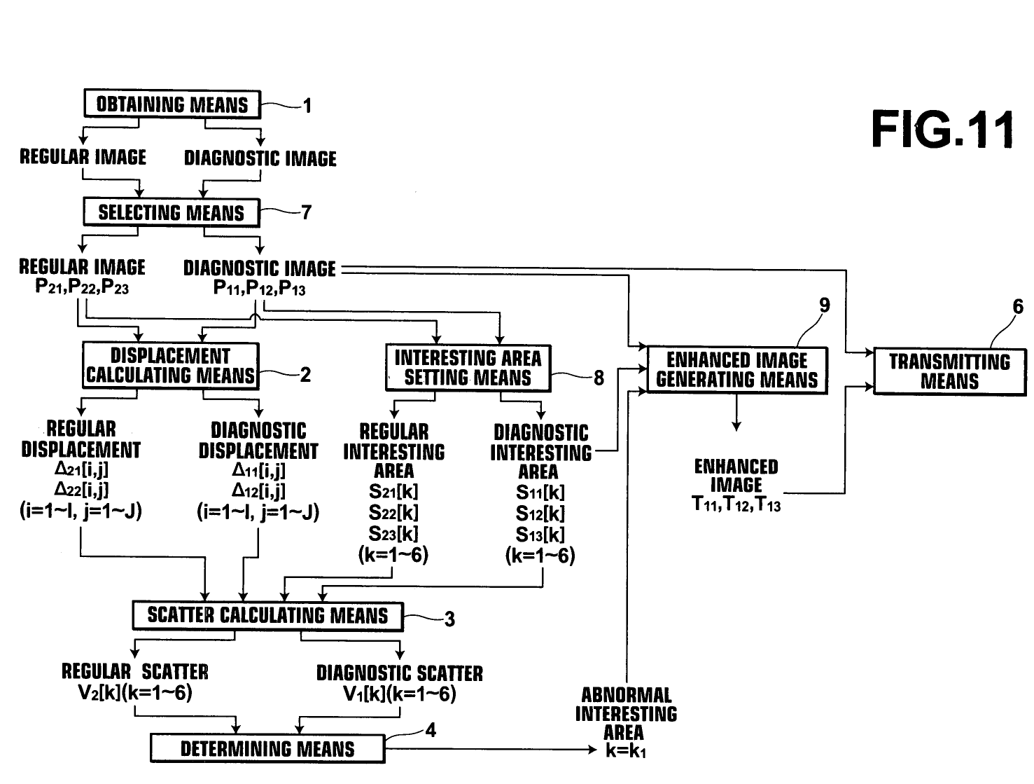

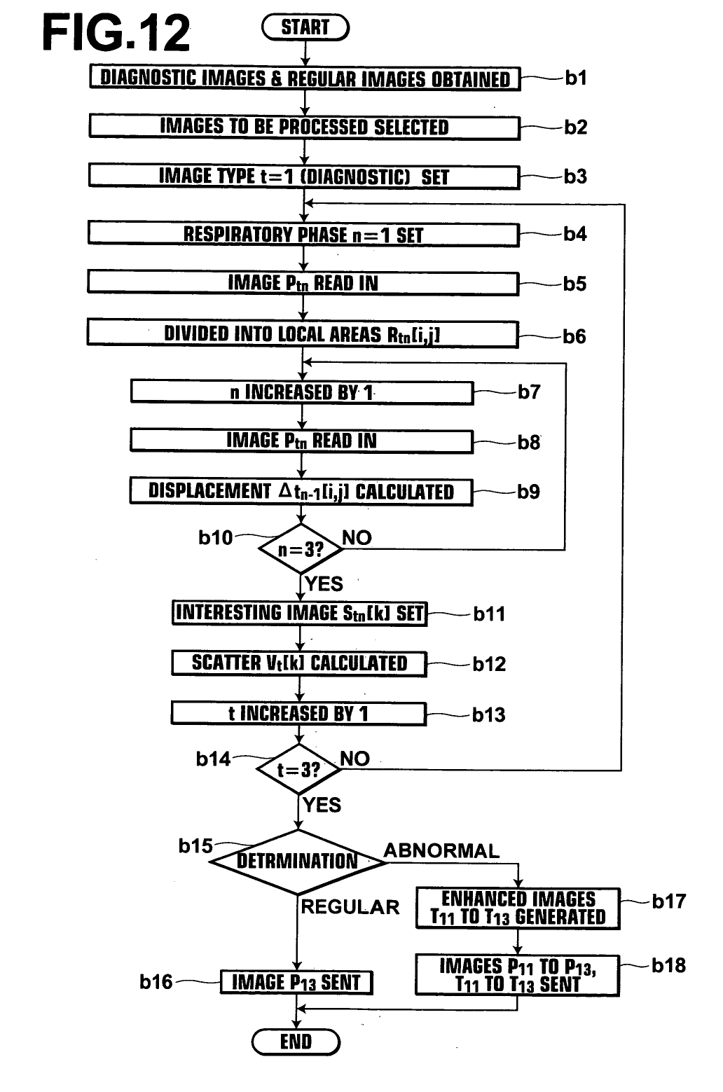

FIG. 11 is a block diagram showing a logical arrangement and flow of data in the image processing server 11 in which the function is installed. In FIG. 11, the means for realizing the functions analogous to those in the first embodiment are given the same signs and the same names. As shown in FIG. 11, a transmitting means 6 is formed by an obtaining means 1 which obtains a plurality of diagnostic images and a plurality of regular images from the image managing system 30, a selecting means 7 which detects the lung in the images for each of the diagnostic images and the regular images obtained, calculates the area of the detected lung and the ratio of the area detected in each of the images to the maximum thereof, thereby selecting a maximum expiration image P11, an intermediate image P12 and a maximum inspiration image P13 of the diagnostic images and a maximum expiration image P21, an intermediate image P22 and a maximum inspiration image P23 of the regular images on the basis of the calculated ratio, a shift calculating means 2 which calculates the shifts Δ11[1,1] to Δ11[I,J], . . . ,ΔΔ12[1,1] to Δ12[I,J] of each of local areas R11[1,1] to R11[I,J] in response to change of the respiratory phase between the images by dividing the maximum expiration diagnostic image P11 into a plurality of local areas R11[1,1], . . . ,R11 [i,j], . . . R11 [I,J] out of the obtained images and carrying out in sequence matching processing where the positions of the divided local areas R11[1,1] to R11[I,J] are aligned with the corresponding positions in the images P12 and P13, and at the same time, the shifts Δ21[1,1] to Δ21[I,J], . . . ,Δ22[1,1] to Δ22[I,J] of each of local areas R21[1,1] to R21[I,J] in response to change of the respiratory phase between the images by dividing the maximum expiration regular image P21 into a plurality of local areas R21[1,1], . . . ,R21[i,j], . . . R21[I,J] and carrying out in sequence matching processing where the positions of the divided local areas R21[1,1] to R21[I,J] are aligned with the corresponding positions in the images P22 and P23, an interesting area setting means 8 which sets interesting areas S1n[1] to S1n[6] and S2n[1] to S2n[6] (n=1, 2 , 3) in the diagnostic images and the regular images selected by the selecting means 7, a scatter calculating means 3 which for each of the diagnostic images and the regular images, calculates the differences of the shift by the shifts of the local areas between the images and the scatter of the difference in shift (the diagnostic scatter:V1[1] to V1[6] the regular scatter:V2[1] to V2[6]) by the interesting areas, a determining means 4 which determines that there is an abnormality in the respiratory function of the examinee when each of the calculated diagnostic scatters V1[1] to V1[6] is larger than each of threshold values Th[1] to Th1[6] set according to the respective regular scatters V2[1] to V2[6], an enhanced image generating means 9 which generates enhanced images T11, T12 and T13 where the interesting area determined to be abnormal in the respiratory function is colored in a translucent color for each of the diagnostic images and a transmitting means 6 which transmits to the client PC 41 the maximum inspiration image P13 when it is determined that there is no abnormality in the respiratory function of the examinee and transmits to the client PC 41 the enhanced images T11, T12 and T13 and the diagnostic images P11, P12 and P13 when it is determined that there is an abnormality in the respiratory function of the examinee.

Each of the means described above is realized in association with a CPU, a main storage system, an external storage means, an input/output interface, an operating system and the like of the image processing server 11 by executing a program installed in the image processing server 11 from a storage medium such as CD-ROM. Further, the order of processing is controlled by the program.

Mainly difference from the first embodiment of the flow of processing to be executed in the second embodiment of the present invention will be described, hereinbelow.

X-raying in the image taking/read-out system 20 and the storage of the image data in the image managing system 30 are the same in the first embodiment.

When the reader operates the client PC 41 to designate the attached information such as the ID of the examinee or the date of x-raying and the pattern of reading (automatic determination of the abnormal respiratory function) and requests execution of the processing, the request is sent to the image processing server 11 and the image processing server 11 starts an image processing program which generates an image necessary for the reading on the basis of the pattern of reading received.

FIG. 12 is a view of a flow chart showing flow of processing executed by the started image processing program.

First the obtaining means 1 obtains at least 3 diagnostic images and at least 3 regular images obtained by retrieving from the database of the image managing system 30 by the retrieving conditions based on the attached information received from the client PC 41 and temporarily stores them in the main storage system or an external storage system of the image processing server 11. (step b1) Each of the diagnostic images and the regular images represent different respiratory phases from the maximum expiration phase to the maximum inspiration phase.

Then the selecting means 7 selects a maximum expiration image, an intermediate image and a maximum inspiration image as images to be processed for each of the diagnostic images and the regular images. (step b2) For example, the lung is detected from each of the images by a known method (e.g., a method disclosed in Japanese Unexamined Patent Publication No. 2003-006661, the area of the detected lung is obtained, and the image where the area of the lung is minimized is taken as the maximum expiration image while the image where the area of the lung is maximized is taken as the maximum inspiration image for each of the diagnostic images and the regular images. Further, for each of the diagnostic images and the regular images, the ratio of the area of the lung in each of the images to the maximum area of the lung is obtained and the image where the ratio is closest to 0.5 is taken as the intermediate image.

Then the value of the image type for distinguishing the type of the image to be processed is set to 1 (in the case of the diagnostic image) (step b3), and the respiratory phase of the image to be processed is set to 1 (the maximum expiration image) (step b4). With this, the diagnostic maximum expiration image P11 to be processed is identified.

Then as in the first embodiment, the shift calculating means 2 reads in the diagnostic maximum expiration image P11 (step b5) and divides the image P11 into local areas R1[1,1], . . . ,R11[i,j], . . . ,R11[I,J] (step b6). Then after the value of the affix n for distinguishing the respiratory phase is added by 1 to 2 (step b7), the shift calculating means 2 reads in the diagnostic intermediate image P12 (step b8) and carries out matching processing where the positions of the local areas R11[1,1] to R11[I,J] are respectively brought into alignment with the corresponding positions in the image P12, thereby calculating the shifts Δ11[1,1] to Δ11[I, J] of each of local areas R11[1,1] to R11[I,J] in response to change from the maximum expiration phase to the intermediate phase (step b9).

When the value of the affix n is further added by 1 to 3 (steps b10 and b7), calculates the shifts (Δ12[1,1] to Δ12[I,J]) of the local areas R11[1,1] to R11[I,J] in response to change from the intermediate phase to the maximum inspiration phase as in the same manner as described above. (steps b8 and b9)

Since the value of the affix n is 3 at this time, the processing by the shift calculating means 2 is ended (step b10), and the interesting area setting means 8 sets interesting areas in the diagnostic image P1n for n=1, 2, 3. Specifically, the interesting area setting means 8 may set interesting areas S1n[1], S1n[2], S1n[3], S1n[4], S1n[5], S1n[6], respectively representing the upper lobe of the right lung, the intermediate lobe of the right lung, the lower lobe of the right lung, the upper lobe of the left lung, the intermediate lobe of the left lung, and the lower lobe of the left lung, on the basis of the result of detection of the lung by the selecting means 7. The “setting of interesting area” means to determine the range of the local areas belonging to the interesting area. The affix in [ ] for distinguishing the interesting areas. The number of the interesting areas may be any.

The scatter calculating means 3 obtains the differences (Δ2[1,1]-Δ1[1,1]) . . . , (Δ2[i,j]-Δ1 [i,j]) . . . , (Δ2[I,J]-Δ1[I,J]) between the shifts of the local areas between images as in the first embodiment, and calculates the divergences of these differences as scatters V1[1] to V1[6]. (step b12)

At this time, the value of the affix t representing the type of image is increased by 1 to 2 (regular image) (steps b13 and b14), and the processing in steps b4 to b12 is repeated on the regular images P21 to P23, whereby regular scatters V2[1] to V2[6] are obtained.

Since the value of the affix t representing the type of image is further increased by 1 to 3 (steps b13 and b14), the processing proceeds to the following determination step.

The determining means 4 reads in the regular scatter V2[k] obtained by the scatter calculating means 3 for the natural numbers k from 1 to 6 and determines that there is an abnormality in the respiratory function of the examinee in the interesting area S1n[k] (n=1, 2, 3) when the diagnostic scatter V1[k] includes a value larger than the threshold value Th (in this embodiment, Th=αVs[k]+β, α and β being allowable constants obtained on the basis of clinical data) and that there is no abnormality in the respiratory function of the examinee when the scatter V1[k] includes no value larger than the threshold value Th. (step b15)

When it is determined by the determining means 4 that the respiratory function of the examinee is regular in all the interesting areas, the transmitting means 6 sends only the image data of the diagnostic maximum inspiration image P13 to the client PC 41. (step b16) On the other hand, when it is determined by the determining means 4 that the respiratory function of the examinee is abnormal, the enhanced image generating means 9 generates enhanced images T11, T12 and T13 where the interesting area determined to be abnormal is colored in a translucent color for each of the diagnostic images (step b17) and the transmitting means 6 transmits to the client PC 41 the enhanced images T11, T12 and T13 and the diagnostic images P11, P12 and P13 (step b18).

The client PC 41 causes the fine liquid crystal display 42 to display the maximum inspiration image P13 on the basis of the image data received from the image processing server 11 when it is determined by the determining means 4 that the respiratory function of the examinee is regular. Whereas, the client PC 41 causes the fine liquid crystal display 42 to display the enhanced images T11, T12 and T13 and the diagnostic images P11, P12 and P13 on the basis of the image data received from the image processing server 11 when it is determined by the determining means 4 that the respiratory function of the examinee is abnormal.

As described above, in the second embodiment of the present invention, whether there is an abnormality in the respiratory function of the examinee is automatically determined in the image processing server 11 by comparison of the scatters in interesting areas with those in the corresponding areas S1n[1] to S1n[6] in the regular images on the basis of a maximum expiration image P11, an intermediate image P12 and a maximum inspiration image P13 selected by the selecting means 7 and a maximum expiration image P21, an intermediate image P22 and a maximum inspiration image P23 selected from regular images of the examinee by the interesting areas S1n[1] to S1n[6] (n=1, 2, 3) set by the interesting area setting means 8. Accordingly, it is possible to attract attention of the reader on the basis of result of determination, which contributes to reduction of the possibility of overlooking the diseased part and can shorten the reading time, thereby improving the diagnostic efficiency.

Further, since the threshold values Th[1] to Th[6] are set by the determining means 4 on the basis of the regular scatters V2[1] to V2[6] which are obtained on the basis of medical chest images when the respiratory function of the examinee is regular, it can be possible to reduce the determination error due to an individual difference between different examinees, whereby the errors in determination are reduced and the diagnostic accuracy and the diagnostic efficiency of the reader can be further improved.

Further, since when it is determined by the determining means 4 that the respiratory function of the examinee is regular, the fine liquid crystal display 42 is caused to display the maximum inspiration image P13 and when it is determined by the determining means 4 that the respiratory function of the examinee is abnormal, the enhanced image generating means 9 generates the enhanced images T11, T12 and T13 where the interesting area determined to be abnormal in the respiratory function is colored in a translucent color for each of the diagnostic images and the generated images are displayed on the fine liquid crystal display 42 of the client PC 41, the diagnostic efficiency of the reader can be improved by changing the image to be provided for reading according to the result of determination.

Further, it is possible to add the processing similar to that by the local shift vector image generating means 5 in the first embodiment, to compare the differences (Δ2[1,1]-Δ1[1,1]) . . . , (Δ2[i,j]-Δ1[i,j]) . . . , (Δ2[I,J]-Δ1[I, J]) between the shifts which belong to the interesting area to have been determined to be abnormal with the predetermined threshold value ThΔ, and in the local area where the difference between the shifts is larger than the predetermined threshold value ThΔ, to generate an image of a color different from the other areas when visualizing the shift vector, whereby the reader can be informed of not only whether there is an abnormality in the respiratory function of an examinee but also the diseased part and accordingly, the diseased part can be more easily recognized and the diagnostic efficiency of the reader can be further improved.

Further, the enhanced image generating means 9 may generate warp images P11″ to P12″ which are obtained by matching the positions of the object in the maximum expiration image P11 and the intermediate image P12 with the corresponding position in the maximum inspiration image P13 by carrying out approximating processing with a two-dimensional ten-order fitting polynomial for the natural numbers n (n=1 and 2) on the basis of the shifts Δn[1,1] to Δn[I,J]) of the central pixels of the local areas, thereby obtaining the shifts of all the pixels in the images P1n in response to change from the maximum expiration phase to the intermediate respiratory phase and from the intermediate respiratory phase to the maximum inspiration phase and by carrying out non-linear strain transforming processing (warping) where each of the pixels in the images from the maximum expiration image P11 to the intermediate respiratory image P12 is shifted on the basis of the sum of the shifts of each pixel in response to change to the maximum expiration, may set interesting areas in the warp images and may enhance the interesting area determined to be abnormal in the warp images. With this arrangement, since the position of each of the pixels in the enhanced image have been matched with the corresponding positions in the maximum inspiration image P12, the shift of each of the local areas can be more easily visually recognized and the diagnostic accuracy and the diagnostic efficiency can be improved.

Further, in the embodiments described above, when the diagnostic images are stored in the external mass storage device 32 of the image managing system 30 after whether there is an abnormality in the respiratory function is determined, the image data of the images which are determined to be regular may be compressed at a high compression rate while the image data of the images which are determined to be abnormal is compressed at a low compression rate or is not compressed.

In the embodiments described above, when it is determined that there is an abnormality in the respiratory function and images of a plurality of the respiratory phases are displayed, the images to be displayed may be three-dimensionally displayed with the direction of depth taken as the direction of time (the direction in which the respiratory phase changes).

What is claimed is:

1. A computer-aided image diagnosis method characterized in that
assuming that arbitrary three respiratory phases of the examinee are taken as first to third respiratory phases in the order of respiration and medical images respectively representing the first to third respiratory phases are taken as first to third images,
it is determined that there is an abnormality in the respiratory function of the examinee when a first shift representing shift of a local area in response to the change from the first respiratory phase to the second respiratory phase is calculated for each of the local areas by carrying out first matching processing where the position of each of a plurality of local areas forming the first image is brought into alignment with the corresponding position in the second image, a second shift representing shift of the local area in response to the change from the second respiratory phase to the third respiratory phase is calculated for each of the local areas by carrying out second matching processing where the position of each of the local areas after the first matching processing is brought into alignment with the corresponding position in the third image,
the difference between the first and second shifts is calculated and
scatter of the calculated difference is larger than a predetermined threshold value.

2. A computer-aided image diagnosis system comprising
a shift calculating means which calculates a first shift representing shift of a local area in response to the change from first respiratory phase to second respiratory phase for each of the local areas by carrying out first matching processing where the position of each of a plurality of local areas forming a first image is brought into alignment with the corresponding position in a second image and a second shift representing shift of the local area in response to the change from the second respiratory phase to a third respiratory phase by carrying out second matching processing where the position of each of the local areas after the first matching processing is brought into alignment with the corresponding position in a third image,
a scatter calculating means which calculates scatter of the difference between the first and second shifts and
a determining means which determines that there is an abnormality in the respiratory function of the examinee when the calculated scatter is larger than a predetermined threshold value,
arbitrary three respiratory phases of the examinee being taken as the first to third respiratory phases in the order of respiration and medical images respectively representing the first to third respiratory phases being taken as first to third images.

3. A computer-aided image diagnosis system as defined in claim 2 further comprising a selecting means which detects the first to third images by detecting the lung in the image for each of a plurality of medical chest images representing different respiratory phases, calculating the ratio of the area of the detected lung to a maximum or minimum area of the lung detected from each of the medical chest images and selecting on the basis of the calculated ratios.

4. A computer-aided image diagnosis system as defined in claim 3 in which the first and third images is a maximum inspiration image where the area of the lung is maximized and a maximum expiration image where the area of the lung is minimized.

5. A computer-aided image diagnosis system as defined in claim 2 in which the predetermined threshold value is set on the basis of the regular scatter which is obtained on the basis of medical chest images when the respiratory function of the examinee is regular.

6. A computer-aided image diagnosis system as defined in claim 2 further comprising a setting means which sets an interesting area in the corresponding position of the first to third images wherein the scatter calculating means calculates the scatter on the local area in the interesting area.

7. A computer-aided image diagnosis system as defined in claim 6 further comprising a detecting means which detects the lung in the first to third images wherein the setting means sets an interesting area in the area of the detected lung.

8. A computer-aided image diagnosis system as defined in claim 6 in which the setting means sets a plurality of the interesting areas, further comprising a display means which, when it is determined that there is an abnormality in the respiratory function of an examinee, displays an interesting area where the scatter of the shifts is larger than the predetermined threshold value in a distinguishable manner where the area can be distinguished from the other areas.

9. A computer-aided image diagnosis system as defined in claim 2 further comprising a display means which, when it is determined that there is an abnormality in the respiratory function of an examinee, displays the first and/or the second shifts of the local area where the scatter of the first and/or the second shifts is larger than the predetermined threshold value in a distinguishable manner where the scatter of the first and/or the second shifts thereof can be distinguished from those of the other local areas.

10. A computer readable medium on which is recorded a computer program which causes a computer to function as
a shift calculating means which calculates a first shift representing shift of a local area in response to the change from first respiratory phase to second respiratory phase for each of the local areas by carrying out first matching processing where the position of each of a plurality of local areas forming a first image is brought into alignment with the corresponding position in a second image and a second shift representing shift of the local area in response to the change from the second respiratory phase to a third respiratory phase by carrying out second matching processing where the position of each of the local areas after the first matching processing is brought into alignment with the corresponding position in a third image,
a scatter calculating means which calculates scatter of the difference between the first and second shifts and
a determining means which determines that there is an abnormality in the respiratory function of the examinee when the calculated scatter is larger than a predetermined threshold value,
arbitrary three respiratory phases of the examinee being taken as the first to third respiratory phases in the order of respiration and medical images respectively representing the first to third respiratory phases being taken as first to third images.
